(19) United States
(12) Patent Application Publication
(10) Pub. No.: US 2014/0058797 A1
(43) Pub. Date: Feb. 27, 2014

(54) DYNAMIC AND SECURE TESTING AND DATA TRANSMISSION INFRASTRUCTURE IN A MULTI LEVEL SUPPLY CHAIN HIERARCHY

(71) Applicants: Nicolas ROY, St-Lambert (CA); Pascal PILON, Montreal (CA); Philippe DESAULNIERS, Mont Saint-Hilaire (CA)

(72) Inventors: Nicolas ROY, St-Lambert (CA); Pascal PILON, Montreal (CA); Philippe DESAULNIERS, Mont Saint-Hilaire (CA)

(21) Appl. No.: 13/593,671

(22) Filed: Aug. 24, 2012

(51) Int. Cl. G06Q 10/00

(52) U.S. Cl. 705/7.36

(57) ABSTRACT

The present relates to a method and system for dynamic and secure testing and data transmission in a multi level supply chain hierarchy. The method and system generates, at an emitting equipment, data related to a component of a product portfolio. The method and system identifies, at the emitting equipment, a receiving equipment for the data. The identification comprises analyzing the data, with respect to the product portfolio and a federated enterprise infrastructure. And the method and system transmits the data, from the emitting equipment to the receiving equipment. Additionally, the generation of the data, the transmission of the data between the emitting equipment and the receiving equipment, and an usage of the data at the receiving equipment, are protected by a security mechanism. The security mechanism prevents an unauthorized actor of the supply chain hierarchy from at least one of: creating, reading, using, and modifying the data.

### TECHNICAL FIELD

The present disclosure relates to the field of data management in a multi level supply chain hierarchy; and more particularly to a dynamic and secure testing and data transmission infrastructure in a multi level supply chain hierarchy.

### BACKGROUND

Manufacturing processes have become more and more complex, involving multiple contributors for the production of a final product. The final product is generally composed of a large number of components, manufactured by the multiple contributors. Furthermore, a component manufactured by a contributor may include sub-components manufactured by another contributor.

One can refer to the notion of supply chain hierarchy, to represent the multiple contributors for the production of a product. The supply chain hierarchy includes an Original Equipment Manufacturer (OEM), in charge of the production of the product. The OEM has tier 1 suppliers, which manufacture components included in the product. Then, the tier 1 suppliers may have tier 2 suppliers, which manufacture components included in their own components, etc. This hierarchy, including the OEM and the various levels of tier n suppliers, is referred to as a multi level supply chain hierarchy.

The various components of the product are manufactured and tested by the multiple contributors of the supply chain hierarchy. One important issue is the management of the data exchanged between the contributors, during the manufacturing and testing of the components. The exchange of data shall be efficient, and shall guarantee the proper level of confidentiality for each type of data exchanged. However, each contributor involved in the supply chain hierarchy already has its own specific information technology infrastructure. And this specific information technology infrastructure may not be adapted to perform test operations, and exchange data related to the test operations, in the context of the multi level supply chain hierarchy. There is therefore a need for a method and system for dynamic and secure testing and data transmission in a multi level supply chain hierarchy.

### SUMMARY

According to a first aspect, the present disclosure provides a method for dynamic and secure testing, and data transmission, in a multi level supply chain hierarchy. For doing so, the method generates, at an emitting equipment, data related to a component of a product portfolio. The method identifies, at the emitting equipment, a receiving equipment for the data. The identification comprises analyzing the data with respect to the product portfolio and a federated enterprise infrastructure of the multi level supply chain hierarchy. And the method transmits the data from the emitting equipment to the receiving equipment. The emitting equipment and the receiving equipment are deployed in the federated enterprise infrastructure of the multi level supply chain hierarchy. The multi level supply chain hierarchy comprises at least one OEM, and N levels of tier n suppliers.

According to a second aspect, the present disclosure provides a system for dynamic and secure testing, and data transmission, in a multi level supply chain hierarchy. For doing so, the system comprises at least one computer implemented storage system, for storing a product portfolio and a federated enterprise infrastructure of the multi level supply chain hierarchy. The system also comprises an emitting equipment, for generating data related to a component of the product portfolio, identifying a receiving equipment for the data, and transmitting the data to the receiving equipment. The identification comprises analyzing the data with respect to the product portfolio and the federated enterprise infrastructure of the multi level supply chain hierarchy. And the system comprises the receiving equipment, for processing the data. The emitting equipment and the receiving equipment are deployed in the federated enterprise infrastructure of the multi level supply chain hierarchy. The multi level supply chain hierarchy comprises at least one OEM and N levels of tier n suppliers.

According to a third aspect, analyzing the data with respect to the product portfolio consists: in determining a type of the data, and analyzing the product portfolio to determine a function of the multi level supply chain hierarchy responsible for using the type of data.

According to a fourth aspect, analyzing the data with respect to the federated enterprise infrastructure consists in: determining the receiving equipment of the federated enterprise infrastructure of the multi level supply chain hierarchy implementing the function.

According to a fifth aspect, the emitting equipment is an engineering definition system, the data consists in technical specifications, and the receiving equipment is a test system.

According to a sixth aspect, the emitting equipment is a test system, the data consists in test data, and the receiving equipment is a data analysis system.

According to a seventh aspect, at least one of the generation of the data at the emitting equipment, the transmission of the data between the emitting equipment and the receiving equipment, and an usage of the data at the receiving equipment, are protected by a security mechanism. The security mechanism prevents an unauthorized actor of the supply chain hierarchy from at least one of: creating, reading, using, and modifying the data.

According to an eight aspect, an authorization for at least one of creating, reading, using, and modifying the data, is granted to an actor of the supply chain hierarchy in relation to an assignment of the actor to a function of the multi level supply chain hierarchy. The function is responsible for the at least one of creating, reading, using, and modifying the data.

According to a ninth aspect, the transmission of data between the emitting equipment and the receiving equipment is performed by means of a dedicated network infrastructure. Further, the dedicated network infrastructure comprises a wide area wireless data network for communicating between premises of the multi level supply chain hierarchy, and self-organized local area wireless data networks for communicating within premises of the multi level supply chain hierarchy.

According to a tenth aspect, the product portfolio and the federated enterprise infrastructure are represented by a distributed data model. The data model is distributed at several premises of the multi level supply chain hierarchy.

The foregoing and other features of the present method and system will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIG. 1 illustrates a system for dynamic and secure testing and data transmission in a multi level supply chain hierarchy, according to a non-restrictive illustrative embodiment;

FIG. 2 illustrates a hierarchy of components of a product, according to a non-restrictive illustrative embodiment;

FIG. 3 illustrates a multi level supply chain hierarchy, according to a non-restrictive illustrative embodiment;

FIGS. 4a and 4b illustrate an exemplary implementation of the system of FIG. 1, according to a non-restrictive illustrative embodiment;

FIGS. 5a and 5b illustrate another exemplary implementation of the system of FIG. 1, according to a non-restrictive illustrative embodiment;

FIG. 6 illustrates a product portfolio, according to a non-restrictive illustrative embodiment;

FIG. 7 illustrates a federated enterprise infrastructure, according to a non-restrictive illustrative embodiment;

FIG. 8 illustrates a dedicated network infrastructure, according to a non-restrictive illustrative embodiment; and

FIG. 9 illustrates a method for dynamic and secure testing and data transmission in a multi level supply chain hierarchy, according to a non-restrictive illustrative embodiment.

### DETAILED DESCRIPTION

To better understand the present specification, the following definitions are provided.

Product/components: a product is a finalized manufactured item, produced at the final stage of a manufacturing process. A product may be composed of several components, the components being optionally composed of sub-components, etc. The components and sub-components are manufactured at intermediate stages of the manufacturing process. Thus, the product is composed of a hierarchy of components. A component of level 1 is included in a product, a component of level 2 is included in a component of level 1, etc. A sub-component refers to a component of level n+1 included in a component of level n.

OEM: Original Equipment Manufacturer. An OEM is an enterprise. It manufactures products that are purchased by another enterprise, and retailed under that purchasing enterprise's brand name. The OEM may purchase for use in its own products components made by other companies, referred to as tier suppliers in the present.

Tier supplier: a manufacturing entity manufacturing a component included in a product manufactured by an OEM.

Tier n supplier: a tier supplier of level n manufacturing a component of level n, included in a product manufactured by an OEM.

Multi level supply chain hierarchy: a supply chain environment composed of a hierarchy of enterprises, which collaborate to manufacture a product. The product is composed of a hierarchy of components. The multi level supply chain hierarchy comprises an OEM, which manufactures the product. And N levels of tier n suppliers, which respectively manufacture components of level n included in the product; n varying from 1 to N. For instance, if N=3, there are three levels of tier n suppliers: tier 1 supplier(s), tier 2 supplier(s), and tier 3 supplier(s).

Member of the supply chain hierarchy: a specific enterprise with a specific role in the supply chain hierarchy. For example, a specific OEM or a specific tier n supplier.

Actor of the supply chain hierarchy: a specific employee of a member of the supply chain hierarchy. Or a functional role within the organization of a member of the supply chain hierarchy (e.g. test technician or repair operator). One or several specific employees within the organization may be affected to a functional role.

Product portfolio: represents the products and components manufactured by the members of the supply chain hierarchy. Also defines different types of data associated to the products and components, as well as access rights for processing these data. The notion of product portfolio will be further defined later in the description.

Federated enterprise infrastructure: represents different types of services implemented at the premises of the members of the supply chain hierarchy. The federated enterprise defines access rights to these services, in relation to the product portfolio. The notion of federated enterprise infrastructure will be further defined later in the description.

Component of a product portfolio: refers to either a product, or a component included in a product. The term component of a product portfolio is used for simplification purposes, to encompass both products, and components included in the products.

Premises: a physical location of an enterprise of the multi level supply chain hierarchy. Equipments used in the manufacturing and testing processes of components of a product portfolio are located at the premises of the enterprise.

The present relates to a system for dynamic and secure testing and data transmission in a multi level supply chain hierarchy.

The system is independent from any contributor involved in the multi level supply chain hierarchy; and can adapt and connect to all specific information technology infrastructures of the contributors.

The system comprises at least one computer implemented storage system. The storage system stores a product portfolio and a federated enterprise infrastructure of the multi level supply chain hierarchy.

The system also comprises an emitting equipment. The emitting equipment generates data related to a component of the product portfolio. The emitting equipment further identifies a receiving equipment for the data. The identification comprises analyzing the data, with respect to the product portfolio and the federated enterprise infrastructure of the multi level supply chain hierarchy. And the emitting equipment transmits the data to the receiving equipment.

The emitting equipment comprises a generic purpose or specialized computer, and dedicated software. The dedicated software is executed on the computer, to generate the data, identify the receiving equipment, and transmit the data.

The system also comprises the receiving equipment. The receiving equipment processes the received data. Examples of processing of the received data include: memorizing the received data, using the received data to execute a functionality of the receiving equipment.

The receiving equipment comprises a generic purpose or specialized computer, and dedicated software. The dedicated software is executed on the computer, to process the received data.

There may be a 1-to-1 or a 1-to-many relationship(s) between the emitting equipment and the receiving equipment(s). In the case of a 1-to-1 relationship, the data is transmitted from one emitting equipment to one receiving equipment. In the case of a 1-to-many relationship, the data is transmitted from one emitting equipment to several receiving equipments. Each of the several receiving equipments is identified by analyzing the data at the emitting equipment, with respect to the product portfolio and the federated enterprise infrastructure of the multi level supply chain hierarchy.

The data are generally either received and used by a test equipment, or generated and sent by a test equipment. In the case of data received and used by a test equipment, the receiving equipment may be the test equipment itself. Alternatively, the receiving equipment may an equipment distinct from the test equipment, responsible for receiving the data on behalf of the test equipment. And in the case of data generated and sent by a test equipment, the emitting equipment may be the test equipment itself. Alternatively, the emitting equipment may an equipment distinct from the test equipment, responsible for sending the data on behalf of the test equipment.

The emitting equipment and the receiving equipment(s) are deployed in the federated enterprise infrastructure of the multi level supply chain hierarchy. The multi level supply chain hierarchy comprises at least one OEM and N levels of tier n suppliers, with N greater or equal to 1 and n varying from 1 to N.

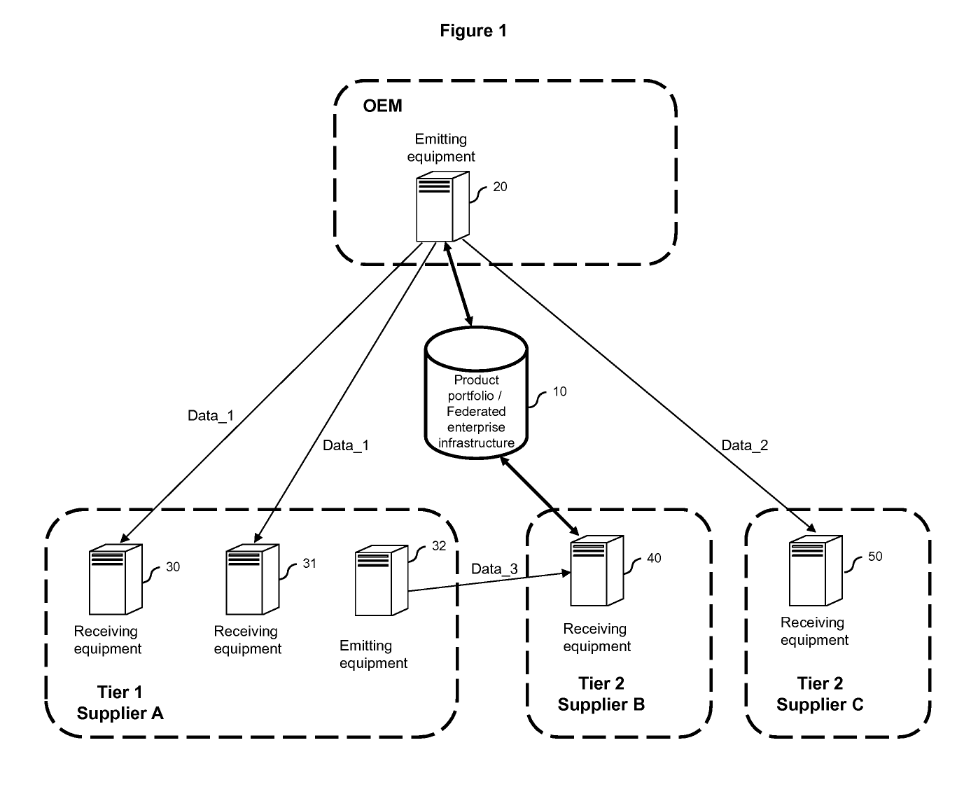

Referring now to FIG. 1, a system for dynamic and secure testing and data transmission in a multi level supply chain hierarchy is represented.

A computer implemented storage system 10, for storing a product portfolio and a federated enterprise infrastructure of the multi level supply chain hierarchy, is represented in FIG. 1.

For illustration purposes, the multi level supply chain hierarchy represented in FIG. 1 comprises an OEM, a tier 1 supplier A, and two tier 2 suppliers B and C. The federated enterprise infrastructure comprises an emitting equipment 20 located at the premises of the OEM, two receiving equipments 30 and 31 located at the premises of the tier 1 supplier A, an emitting equipment 32 located at the premises of the tier 1 supplier A, a receiving equipment 40 located at the premises of the tier 2 supplier B, and a receiving equipment 50 located at the premises of the tier 2 supplier C.

The emitting equipment 20 generates a first data: data_1, related to a first component of the product portfolio. The first data data_1 is analyzed with respect to the product portfolio and the federated enterprise infrastructure stored in the computer implemented storage system 10. Based on the analysis, two receiving equipments 30 and 31 are determined. The first data data_1 is transmitted from the emitting equipment 20, to the receiving equipments 30 and 31. The first data data_1 is further processed at the receiving equipments 30 and 31.

The emitting equipment 20 generates a second data: data_2, related to a second component of the product portfolio. The second data data_2 is analyzed with respect to the product portfolio and the federated enterprise infrastructure stored in the computer implemented storage system 10. Based on the analysis, a receiving equipment 50 is determined. The second data data_2 is transmitted from the emitting equipment 20, to the receiving equipment 50. The second data data_2 is further processed at the receiving equipment 50.

The emitting equipment 32 generates a data: data_3, related to another component of the product portfolio. The data data_3 is analyzed with respect to the product portfolio and the federated enterprise infrastructure stored in the computer implemented storage system 10. Based on the analysis, a receiving equipment 40 is determined. The data data_3 is transmitted from the emitting equipment 32, to the receiving equipment 40. The data data_3 is further processed at the receiving equipment 40.

Although not represented on FIG. 1 for simplification purposes, an emitting equipment located at tier 1 supplier A/tier 2 supplier C may transmit data to a receiving equipment located at the OEM. And an emitting equipment located at tier 2 supplier B may transmit data to a receiving equipment located at tier 1 supplier A.

FIG. 1 illustrates that data may be transmitted in a 1-to-1 relationship (data_2 and data_3), or in a 1-to-many relationship (data_1). FIG. 1 also illustrates that data may be transmitted between an OEM and tier n suppliers (data_1 between an OEM and a tier 1 supplier, data_2 between an OEM and a tier 2 supplier), or between tier suppliers (data_3 between a tier 2 and a tier 1 supplier).

A component of the product portfolio consists of either a product or a component. And a product may be composed of a hierarchy of components. In a particular aspect, a component may consist of a hardware part, a software, or a sub-system.

The physical components (hardware parts and sub-systems) which compose a product may be of one or several types, including: electrical components, optical components, electronic components, mechanical components, mechatronic components.

In the general case, a product is composed of several sub-systems. Each sub-system consists of hardware parts and/or software. A sub-system is designed to provide a specific set of functionalities. The assembly of the sub-systems of a product, and the interactions between the functionalities of these sub-systems, provides the global functionalities of the product. A product may also consist in the assembly of sub-system(s), and standalone hardware part(s).

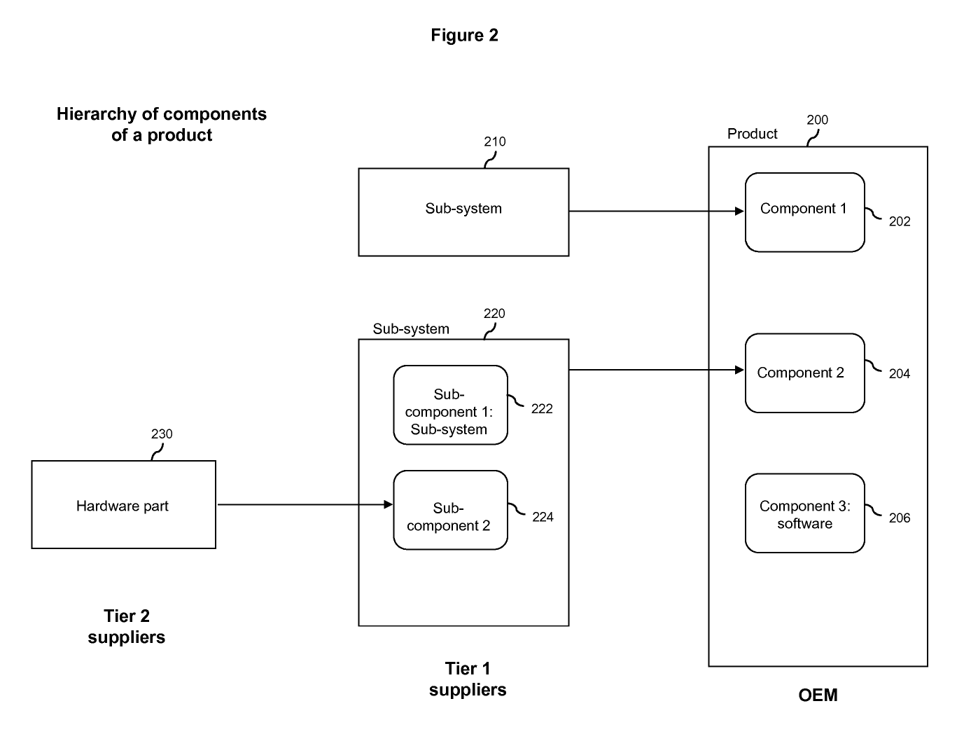

Referring now to FIG. 2, a hierarchy of components of a product is represented.

A product 200 manufactured by an OEM is represented in FIG. 2. The product 200 is composed of three components. A first component 202 is manufactured by a first tier 1 supplier. A second component 204 is manufactured by a second tier 1 supplier. And a third component 206 is manufactured by the OEM.

The first tier 1 supplier manufactures a component 210, corresponding to component 202 of product 200.

The second tier 1 supplier manufactures a component 220, corresponding to component 204 of product 200. The component 220 is composed of two sub-components. A first sub-component 222 is manufactured by the second tier 1 provider. And a second sub-component 224 is manufacturer by a tier 2 supplier.

The tier 2 supplier manufactures a component 230, corresponding to sub-component 224 of component 220.

The components and sub-components introduced in FIG. 2 may consist in the following. Component 202 is a sub-system manufactured by the first tier 1 supplier (210). Component 204 is a sub-system manufactured by the second tier 1 supplier (220). Component 206 is a software produced by the OEM. The sub-system 220 is composed of a sub-system 222 manufactured by the second tier 1 supplier, and of a hardware part 224, manufactured by the tier 2 supplier (230).

For simplification purposes, only two levels of tier n suppliers have been represented in FIG. 2. However, additional levels of tier n suppliers (tier 3, tier 4, etc) may manufacture additional components, which are integrated in the product 200.

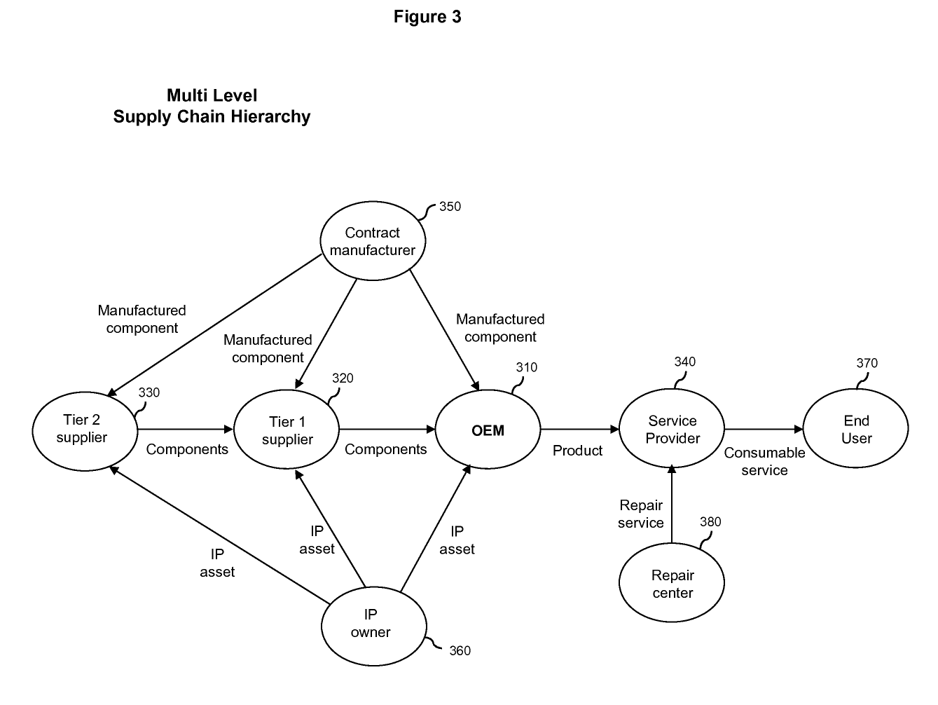

Referring now to FIG. 3, a multi level supply chain hierarchy is represented.

An Original Equipment Manufacturer (OEM) 310 designs, manufactures, and commercializes a product. The OEM is a direct supplier of a service provider 340, by selling the product to the service provider 340. The OEM may manufacture the entire product. The OEM may also assemble components manufactured by other suppliers, to build the product. And the OEM may perform a combination of manufacturing and assembling operations.

The product sold by the OEM 310 to the service provider 340 is further used by the service provider 340, to offer a consumable service to an end user 370. Alternatively, the OEM 310 may sell the product directly to end users 370, without an intermediate service provider 340. For example, a manufacturer of mobile phones may be considered as an OEM 310. The manufacturer of mobile phones may sell phones directly to end users 370, via physical and/or on-line stores. The manufacturer of mobile phones may also sell phones to a network operator (the service provider 340). In this latter case, the network operator makes the phones available to end users 370, as part of a mobile communication service.

The service provider 340 may subcontract repair activities of defective products to a repair center 380. A product commercialized by the OEM 310 may be defective, and the defect may be detected at the service provider level 340, or at the end user level 370. Alternatively, the product commercialized by the OEM 310 may be fully operational. However, over time, it may become defective, due to an inappropriate usage by the end user 370, to a defect in the conception of the product, or to normal wear of components subject to aging (such as batteries, hard disk drives, etc).

The product commercialized by the OEM 310 is composed of components; including for example software, hardware parts, and sub-systems. In the context of the multi level supply chain hierarchy represented in FIG. 3, a tier 1 supplier 320 supplies components, which are integrated in the product commercialized by the OEM 310.

For example, if the OEM 310 is a manufacturer of mobile phones, the product is a mobile phone. A first component of the product is a radio communication sub-system, including sub-components: Radio Frequency (RF) hardware parts, and a RF communication software. A second component of the product is a central processing sub-system, including sub-components: hardware parts (e.g. a micro-processor), and a software (e.g. an operating system). And a third component of the product is a display sub-system, including sub-components: hardware parts composing a screen, a dedicated micro-processor to control the screen, and a screen management software executed on the dedicated micro-processor. In this case, the tier 1 supplier 320 may manufacture the first component; and another tier 1 supplier (not represented in FIG. 3) may manufacture the third component. The notion of tier 1 supplier implies that they manufacture components, which are directly supplied to the OEM 310. The OEM 310 may manufacture the second component, and assemble the three components to build the final product (the mobile phone).

A component manufactured by a tier 1 supplier 320 may contain sub-components, as illustrated in the previous example. The sub-components may be manufactured by a tier 2 supplier 330, or directly by the tier 1 supplier 320. For example, referring to the previous example, some RF hardware parts of the first component may be manufactured directly by the tier 1 supplier 320. And some RF hardware parts of the first component may be provided by the tier 2 supplier 330. Additionally, the software of the first component may be generated directly by the tier 1 supplier 320.

Generally speaking, the supply chain hierarchy comprises a hierarchy of level 1 to level N tier suppliers. A tier n supplier (supplier of level n, with n comprised between 1 and N−1 included) manufactures components, which may integrate sub-components from at least one tier n+1 (supplier of level n+1) supplier. And as already mentioned, the OEM 310 manufactures a product, which may integrate components from at least one tier 1 supplier 320. There is no limit on the value of N, which varies from one implementation of a supply chain hierarchy to another. In FIG. 3, only two levels are represented for simplification purposes: tier 1 supplier 320, and tier 2 supplier 330. However, a tier 3 supplier, a tier 4 supplier, etc, may also be part of the supply chain hierarchy.

A tier n supplier may manufacture a component, which integrates sub-components from more than one tier n+1 supplier. For instance, the tier 1 supplier 320 may integrate sub-components from the tier 2 supplier 330, as well as from additional tier 2 suppliers (not represented in FIG. 3).

The OEM 310 may be considered as a tier 0 supplier, with respect to its respective tier 1 supplier(s). From the perspective of the service provider 340, the OEM 310 may be considered as a tier 1 supplier, providing a final product (instead of components).

The OEM 310, and some tier n suppliers, often subcontract some manufacturing activities (e.g. manufacturing of hardware parts) to a contract manufacturer 350. A single contract manufacturer 350 is represented in FIG. 3 (for simplification purposes) for the OEM 310, the tier 1 supplier 320, and the tier 2 supplier 330. However, each tier n supplier may have its own contract manufacturer, or possibly several different contract manufacturers. A contract manufacturer may be considered as a specific type of tier supplier. For example, the contract manufacturer 350 may be considered as a tier 1 supplier for the OEM 310, as a tier 2 supplier for the tier 1 supplier 320, and as a tier 3 supplier for the tier 2 supplier 330.

The OEM and some tier n suppliers often depend on Intellectual Property (IP) assets, owned by an IP owner 360. A single IP owner 360 is represented in FIG. 3 (for simplification purposes) for the OEM 310, the tier 1 supplier 320, and the tier 2 supplier 330. However, each tier n supplier may depend on its own IP owner, or possibly several different IP owners. An IP asset defines Intellectual Property rights associated to a component—or to a portion of a component—manufactured by a tier n supplier (including the OEM as a tier 0 supplier). Usually, for each instance of the component manufactured (and/or sold) by the tier n supplier, a licensing fee shall be paid to the IP owner. A tier n supplier may also play the role of an IP owner with regards to upper level tier suppliers. In particular, OEMs usually own IP assets, which can be enforced to tier 1 suppliers, tier 2 suppliers, etc.

The OEM plays a specific role in the manufacturing supply chain: it is responsible of the compliance of the product it manufactures, with respect to technical specifications of this product. The technical specifications define how the product shall operate, by means of measureable properties of the product. The measurable properties are measured by means of a suite of tests performed by the OEM. The result of a test consists in a measured property (the measure of the property by performing the test). Based on the value of the measured property, the corresponding test is declared as passed or failed. The test is passed if the measured property is compliant with the technical specifications. If all the tests associated to the technical specifications of a product are passed, the product is compliant with the technical specifications.

However, as described previously, the product may include components provided by at least one tier 1 supplier. Then, the components provided by at least one tier 1 supplier may include sub-components provided by at least one tier 2 supplier. And the same principle applies, up to the tier N suppliers of the manufacturing supply chain. A tier n supplier manufactures components according to technical specifications. The manufacturing may include the assembly of sub-components provided by a tier n+1 supplier (or by a contract manufacturer). The manufactured components are integrated by a tier n−1 supplier in its own components. The components manufactured by the tier n supplier shall be compliant, with respect to their technical specifications. A suite of tests is performed for each component manufactured by the tier n supplier, to evaluate the compliance with respect to the technical specifications. The testing process is the same as the one described for the product manufactured by the OEM.

In a particular aspect, analyzing the data with respect to the product portfolio consists in determining a type of the data, validating its authenticity, and analyzing the product portfolio to determine a function of the multi level supply chain hierarchy responsible for using the type of data.

For each specific component of the product portfolio, the different types of data which may be generated for this specific component are memorized. Further, for each type of data, the different functions of the multi level supply chain hierarchy which use this type of data are memorized. Thus, when a data is generated by an emitting equipment, the type of the data is determined. And the corresponding functions of the multi level supply chain hierarchy (memorized in the product portfolio) using this type of data are determined.

In an exemplary embodiment, a function consists of a combination of a member of the supply chain hierarchy, and a role of an actor of the supply chain hierarchy. Members of the supply chain hierarchy have been identified in relation to FIG. 3, and include: a specific OEM, a specific tier n supplier, a specific contract manufacturer, etc. The role of an actor defines specific tasks which are performed by the actor. These tasks are related to the testing of the components of the product portfolio. Examples of roles of an actor include: engineer (example of task: generating technical specifications), test operator (example of task: testing a component), test engineer (example of task: analyzing the results of the tests), etc.

In another particular aspect, analyzing the data with respect to the federated enterprise infrastructure consists in determining the receiving equipment of the federated enterprise infrastructure of the multi level supply chain hierarchy for implementing the function.

For each function memorized in the product portfolio, one corresponding equipment (or optionally several corresponding equipments) is memorized in the federated enterprise infrastructure. The corresponding equipment implements the function. Thus, having a specific function, the federated enterprise infrastructure is analyzed, to determine the receiving equipment which implements the specific function. The receiving equipment is located at the premises of the specific member of the supply chain hierarchy corresponding to the specific function.

In another aspect the emitting equipment is an engineering definition system, the data consists in technical specifications, and the receiving equipment is a test system.

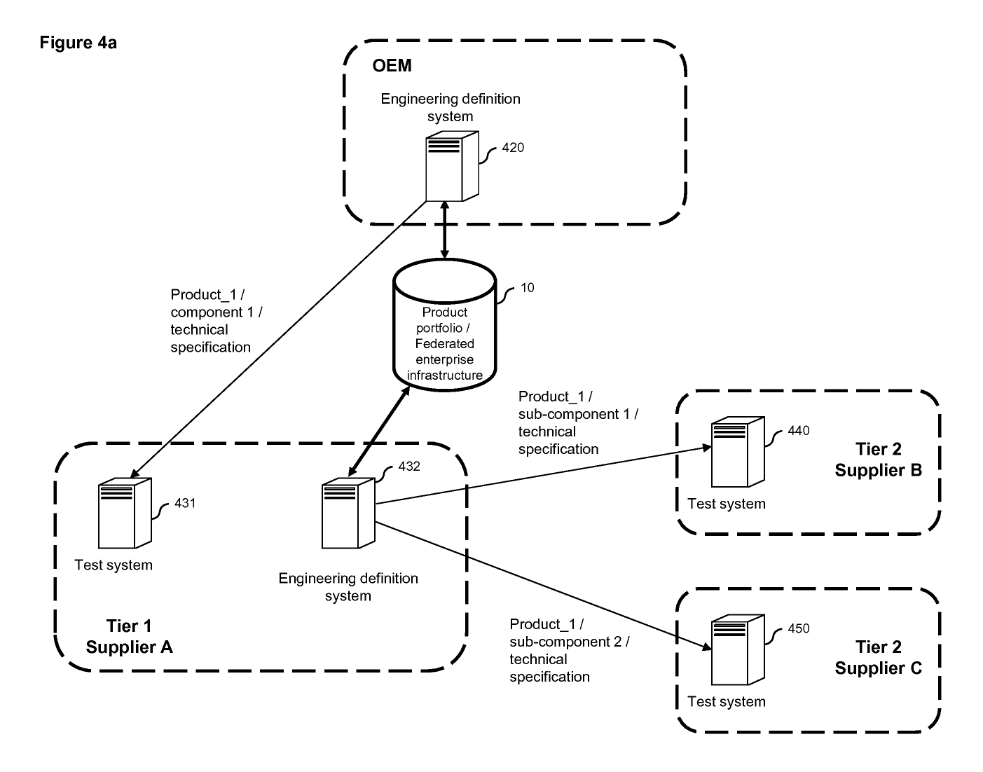

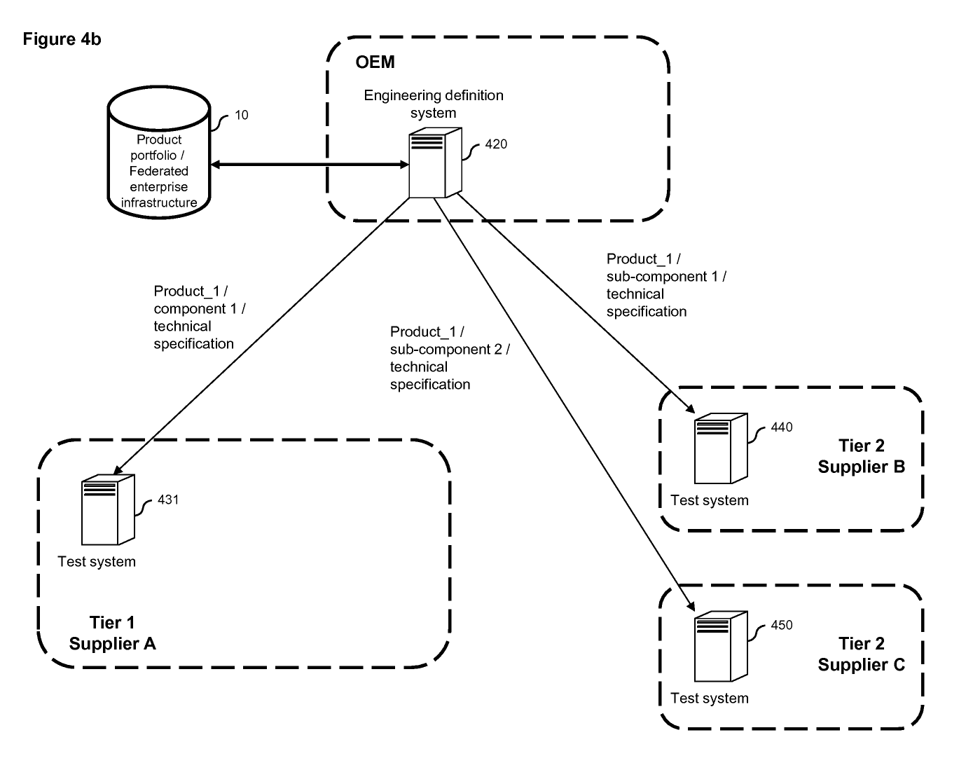

Referring now to FIG. 4a, an exemplary implementation of the system represented in FIG. 1, corresponding to the present aspect, is represented. We consider that the OEM represented in FIG. 4a manufactures one product: product 1. Product 1 comprises one component: component 1. Component 1 comprises two sub-components: sub-component 1 and sub-component 2. Component 1 is manufactured by the tier 1 supplier A, sub-component 1 is manufactured by the tier 2 supplier B, and sub-component 2 is manufactured by the tier 2 supplier C; respectively represented in FIG. 4a.

A first emitting equipment is an engineering definition system 420, located at the premises of the OEM. The engineering definition system 420 generates a data consisting in technical specifications corresponding to component 1 of product 1. These technical specifications are analyzed with respect to the product portfolio and the federated enterprise infrastructure stored in the computer implemented storage system 10. Based on the analysis, the receiving equipment is determined to be a test system 431, located at the premises of the tier 1 supplier A. The specifications are transmitted, by the engineering definition system 420, to the test system 431. The specifications are further used by the test system 431, to perform tests on the component 1 of the product 1.

Another emitting equipment is an engineering definition system 432, located at the premises of the tier 1 supplier A. The engineering definition system 432 generates a data consisting in technical specifications corresponding to sub-component 1 of product 1. These technical specifications are analyzed with respect to the product portfolio and the federated enterprise infrastructure stored in the computer implemented storage system 10. Based on the analysis, the receiving equipment is determined to be a test system 440, located at the premises of the tier 2 supplier B. The specifications are transmitted, by the engineering definition system 432, to the test system 440. The specifications are further used by the test system 440, to perform tests on the sub-component 1 of the product 1.

The engineering definition system 432 also generates a data consisting in technical specifications corresponding to sub-component 2 of product 1. These technical specifications are analyzed with respect to the product portfolio and the federated enterprise infrastructure stored in the computer implemented storage system 10. Based on the analysis, the receiving equipment is determined to be a test system 450, located at the premises of the tier 2 supplier C. The specifications are transmitted, by the engineering definition system 432, to the test system 450. The specifications are further used by the test system 450, to perform tests on the sub-component 2 of the product 1.

FIG. 4a illustrates a use case where an OEM generates technical specifications for components included in its products, and manufactured by tier 1 suppliers. These technical specifications are transmitted to test systems located at the premises of the tier n suppliers. FIG. 4a also illustrates that a tier n supplier generates technical specifications for sub-components included in its components, and manufactured by tier n+1 suppliers. These technical specifications are transmitted to test systems located at the premises of the tier n+1 suppliers.

FIG. 4b represents an alternative exemplary implementation corresponding to the present aspect. In this alternative exemplary implementation, the engineering definition system 420 located at the premises of the OEM generates the technical specifications of all the components (component 1) and sub-components (sub-component 1 and sub-component 2) of product 1. And these technical specifications are transmitted to the appropriate test systems 431, 440, and 450 respectively.

FIG. 4b illustrates a use case where an OEM generates technical specifications for components included in its products, and manufactured by different levels of tier n suppliers (tier 1, tier 2, etc). These technical specifications are transmitted to test systems located at the premises of the tier n suppliers.

In another aspect, the emitting equipment is a test system, the data consists in test data, and the receiving equipment is a data analysis system.

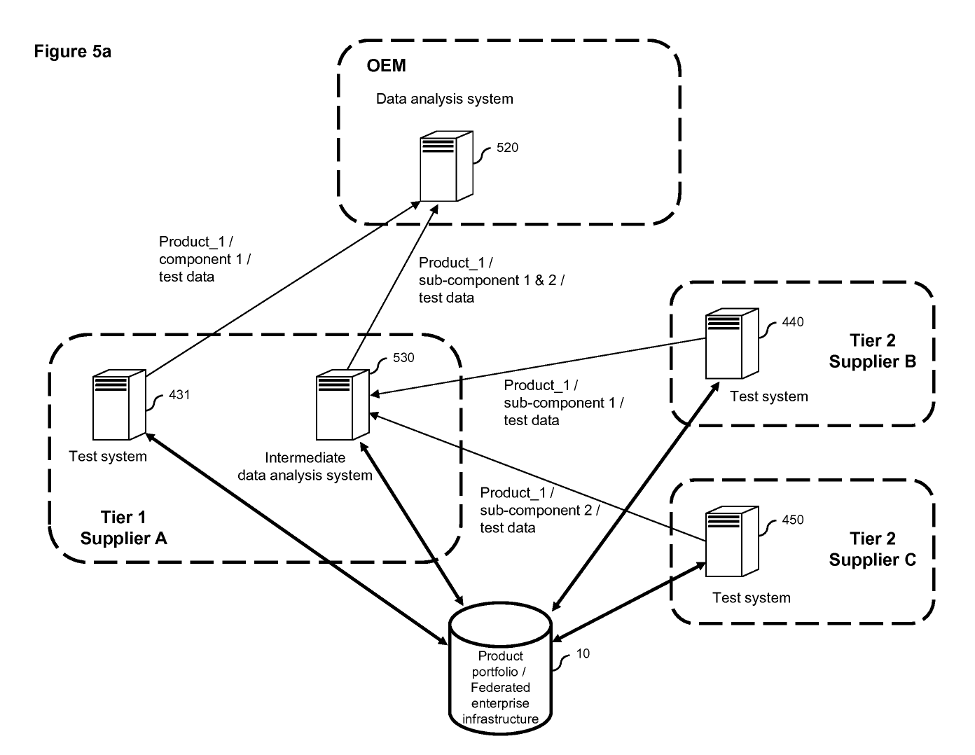

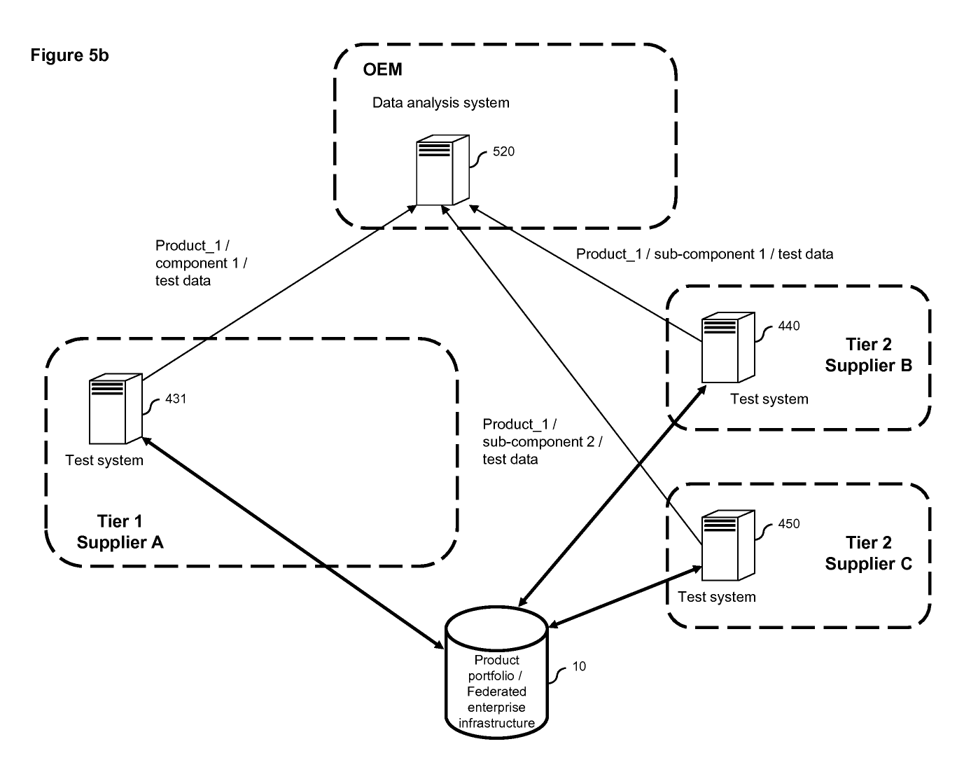

Referring now to FIG. 5a, an exemplary implementation of the system represented in FIG. 1, corresponding to the present aspect, is represented. The test systems 431, 440, and 450 represented in FIG. 5a correspond to the test systems represented in FIG. 4a.

A first emitting equipment is the test system 431, located at the premises of the tier 1 supplier A. The test system 431 generates a first data, consisting in test data corresponding to a test of component 1 of product 1. These test data are analyzed with respect to the product portfolio and the federated enterprise infrastructure stored in the computer implemented storage system 10. Based on the analysis, the receiving equipment is determined to be a data analysis system 520, located at the premises of the OEM. The test data are transmitted, by the test system 431, to the data analysis system 520. The test data are further used by the data analysis system 520, for instance to analyze the compliance of component 1 of product 1.

Another emitting equipment is the test system 440, located at the premises of the tier 2 supplier B. The test system 440 generates a data, consisting in test data corresponding to a test of sub-component 1 of product 1. These test data are analyzed with respect to the product portfolio and the federated enterprise infrastructure stored in the computer implemented storage system 10. Based on the analysis, the receiving equipment is determined to be an intermediate data analysis system 530, located at the premises of the tier 1 supplier A. The test data are transmitted, by the test system 440, to the intermediate data analysis system 530. The test data are further used by the intermediate data analysis system 530, for instance to analyze (at the tier 1 supplier A level) the compliance of sub-component 1.

Additionally, the test data are analyzed with respect to the product portfolio and the federated enterprise infrastructure stored in the computer implemented storage system 10. Based on the analysis, a receiving equipment is determined to be the data analysis system 520, located at the premises of the OEM. The test data are forwarded by the intermediate data analysis system 530, to the data analysis system 520. The test data are further used by the data analysis system 520, for instance to analyze (at the OEM level) the compliance of sub-component 1.

Another emitting equipment is the test system 450, located at the premises of the tier 2 supplier C. The test system 450 generates a data, consisting in test data corresponding to a test of sub-component 2 of product 1. These test data are analyzed with respect to the product portfolio and the federated enterprise infrastructure stored in the computer implemented storage system 10. Based on the analysis, the receiving equipment is determined to be the intermediate data analysis system 530, located at the premises of the tier 1 supplier A. The test data are transmitted, by the test system 450, to the intermediate data analysis system 530. The test data are further used by the intermediate data analysis system 530, for instance to analyze (at the tier 1 supplier A level) the compliance of sub-component 2.

Additionally, the test data are analyzed with respect to the product portfolio and the federated enterprise infrastructure stored in the computer implemented storage system 10. Based on the analysis, a receiving equipment is determined to be the data analysis system 520, located at the premises of the OEM. The test data are forwarded, by the intermediate data analysis system 530, to the data analysis system 520. The test data are further used by the data analysis system 520, for instance to analyze (at the OEM level) the compliance of sub-component 2.

In an alternative embodiment, a single equipment at the tier 1 supplier A may centralize the test data, and transmit them to the OEM. For example, the intermediate data analysis system 530 may centralize all test data for component 1, sub-component 1, and sub-component 2; and transmit them to the data analysis system 520 of the OEM.

FIG. 5a illustrates a use case where test data generated at a level n+1 of the supply chain hierarchy (tier n+1 supplier) are automatically transmitted to level n (tier n supplier), where they are analyzed and further transmitted to level n−1 (tier n−1 supplier); up to the OEM level (which can be seen as a tier 0 supplier). Also, at a tier n supplier, all the test data corresponding to components and sub-components of the same product may be aggregated, before transmission to the appropriate tier n−1 supplier. These test data may have been generated at the tier n supplier, or generated and transmitted by a tier i+1 supplier.

FIG. 5b represents an alternative exemplary implementation corresponding to the present aspect. In this alternative exemplary implementation, the test systems (431, 440, 450) located at the premises of the tier suppliers (tier 1 supplier A and tier 2 suppliers B and C) generate test data, and automatically transmit these test data to the data analysis system 520 located at the OEM premises.

FIG. 5b illustrates a use case where the test data generated by a tier n supplier are directly transmitted from the tier n supplier to the OEM.

In another aspect, at least one of: the generation of the data at the emitting equipment, the transmission of the data between the emitting equipment and the receiving equipment, and an usage of the data at the receiving equipment, are protected by a security mechanism. The security mechanism prevents an unauthorized actor of the supply chain hierarchy from at least one of: creating, reading, using, and modifying the data.

At the emitting equipment, an actor may create and modify the data, as well as read and use the data when applicable. Specific authorizations are granted to actors for each of these actions.

At the receiving equipment, an actor may read and use the data, as well as modify the data when applicable. Specific authorizations are granted to actors for each of these actions.

The security mechanism at the emitting equipment and receiving equipment may consist of standard access rights management used in Information Technologies. They include access rights management for having access to the emitting and receiving equipments. They also include access rights management to specific softwares of the emitting and receiving equipments. The specific softwares are used to process the data: create the data, modify the data, read the data, use the data.

The transmission of the data between the emitting equipment and the receiving equipment shall be protected by a security mechanism, such as a ciphering mechanism. The ciphering mechanism prevents unauthorized actors from reading, modifying, and using the data during their transmission. In the general case, no actor is authorized to access (read, modify, use) the data during their transmission. Ciphering mechanisms comprise encryption/decryption technologies, and digital signature technologies.

In a particular aspect, an authorization for at least one of creating, reading, using, and modifying the data, is granted to an actor of the supply chain hierarchy in relation to an assignment of the actor to a function of the multi level supply chain hierarchy; wherein the function is responsible for the at least one of creating, reading, using, and modifying the data.

As previously mentioned, several types of data are associated to a specific component of the product portfolio (e.g. technical specification, test data). For each type of data, access rights are granted for processing the data. The access rights comprise: creating the data, reading the data, using the data, and modifying the data. One (or several) function of the multi level supply chain hierarchy is associated to each access right. For example, a function with the access right for using the data is responsible for using the data. An actor of the supply chain hierarchy, who is assigned to the function, is granted the corresponding access rights to the type of data.

For example, the function Supplier n/Test operator is granted the access right to create test data, for a component manufactured by Supplier n. An actor of the supply chain hierarchy assigned to the function Supplier n/Test operator, has the authorization to create test data related to the component manufactured by Supplier n. In the general case, an employee of Supplier n may be assigned to function Supplier n/Test operator. However, an employee of another enterprise (for example an employee from the OEM) may also be assigned to function Supplier n/Test operator.

Each enterprise of the multi level supply chain hierarchy has its own security infrastructure, to manage access rights of its employees to hardware and software resources. In particular, a corporate directory service may be used by each enterprise, to manage access rights of its own employees. A federated directory service may be deployed on top of the security infrastructure of each enterprise. The federated directory service manages the access rights of the actors of the supply chain hierarchy. The federated directory service collaborates with the corporate directory services of each enterprise, so that an actor who is assigned to a function providing access rights to specific data, is effectively granted access to the specific data at the premises of the enterprise where these data are processed (e.g. created, modified, read, used).

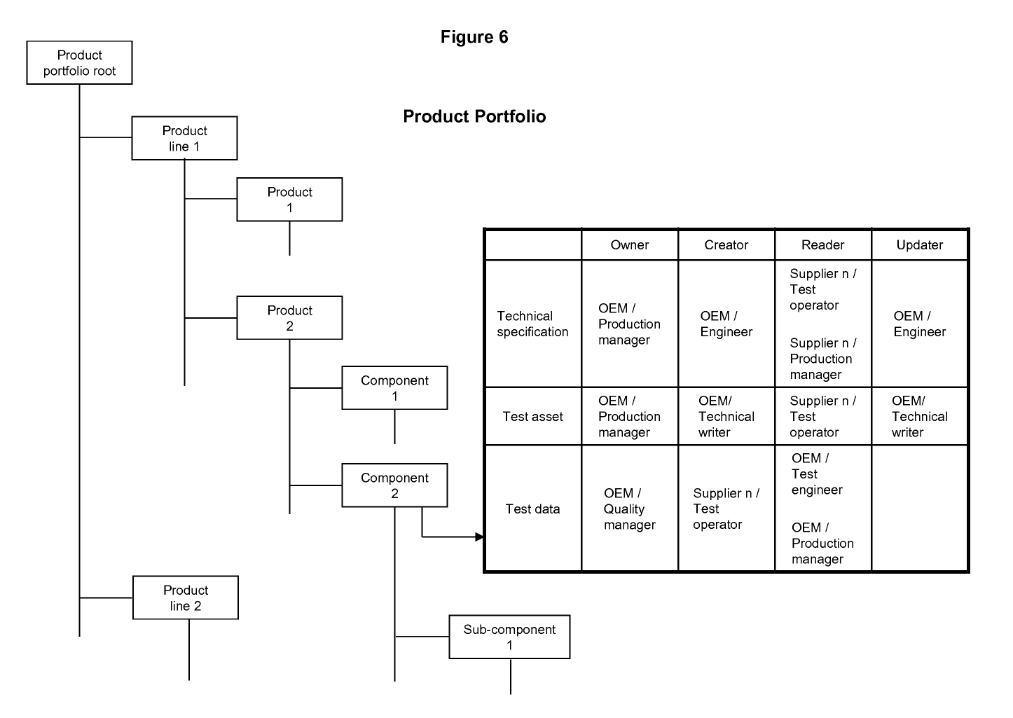

In another aspect, referring now to FIG. 6, a product portfolio will be described.

A product portfolio includes a hierarchy of entities, to represent the relationships between products and components included in the products. In general, an OEM manufactures several products. The product portfolio represents the relationships between the products and their components, under the responsibility of the OEM.

The product portfolio represented in FIG. 3 includes a product portfolio root. The portfolio root may be used to identify a specific OEM. Then, the portfolio root is divided in product lines. For illustration purposes, two product lines are represented in FIG. 6: product line 1 and product line 2. A product line may be composed of one or several products with common characteristics. Alternatively, a product line may be composed of one or several products sold to the same service provider.

A product line is composed of one or several products. For illustration purposes, two products included in product line 1 are represented in FIG. 6: product 1 and product 2. The products are manufactured by the OEM. Then, a product is composed of components. As illustrated in FIG. 2, a product may be decomposed in a hierarchy of components and sub-components included in the product. Each component/sub-components is manufactured by a tier n supplier (or a contract manufacturer). For illustration purposes, two components included in product 2 are represented in FIG. 6: component 1 and component 2. And a sub-component included in component 2 is represented: sub-component 1. Component 1 and component 2 are manufactured by tier 1 suppliers (or contract manufacturers). Sub-component 1 is manufactured by a tier 2 supplier (or a contract manufacturer). The hierarchy of components and sub-components may go deeper (although not represented in FIG. 6 for simplification purposes), involving sub-components manufactured by tier 3 suppliers, tier 4 suppliers, etc.

A product portfolio also includes several types of data, associated to the entities of the product portfolio. Specifically, several types of data are defined for the products and the components (and sub-components). Each type of data is used in a specific context: manufacture of a product or component, test of a product or component, etc. For illustration purposes, three types of data are associated to component 2: technical specifications, test assets, and test data. These three types of data may be associated to any product, component, or sub-component represented in FIG. 6. The technical specifications may include information defining how a product/component shall operate, by means of measureable properties. The measurable properties are measured by means of a suite of tests performed on the product/component. The technical specifications may further include information defining how the test shall be performed, what shall be measured, what are the expected results of the tests. Thus, the technical specifications may include test plans, test sequences, etc. The test assets provide data for executing the tests (e.g. schemas, user guides, test instructions, information related to the test equipments and the testing infrastructure, and software to be loaded onto test equipments). The test data may include the results of the tests (e.g. the properties of a specific product or component, as they have been measured when passing the test). The test data may also include information related to the compliance of a component, with respect to its technical specifications, based on the results of the tests of the components.

The context of the present method and system is the testing and compliance of products and components in a multi level supply chain hierarchy. Thus, the aforementioned types of data are related to test and compliance operations. However, additional types of data may be defined as well.

Several access rights are defined for the types of data. FIG. 6 illustrates the following access rights: owner, creator, reader, and updater. The owner is an entity which is responsible for the data. In particular, the owner manages the access rights of other entities to the data. The creator is an entity which creates the data. The reader is an entity which has access to the data. The access may consist in reading the data, and/or using the data for a specific purpose (e.g. using the data to perform a test of a component with a test equipment). Thus, in FIG. 6, the actions of reading and using the data are grouped under the same access right (reader). Alternatively, a specific access right (reader) may be defined for reading the data, and a specific access right (user) may be defined for using the data. The updater is an entity which may update the data, after their initial creation.

For each component of the product portfolio, for each type of data associated to this component, and for each access right defined in relation to the types of data, one or several corresponding functions may be specified. The one or several corresponding functions are granted the access right, to the type of data, for the component of the product portfolio. As previously mentioned, a function consists of a combination of a member of the supply chain hierarchy, and a role of an actor of the supply chain hierarchy. Members of the supply chain hierarchy have been identified in relation to FIG. 3, and include: an OEM, a tier n supplier, a contract manufacturer, a service provider, etc. The role of an actor defines specific tasks which are performed by the actor. Examples of roles of an actor include: production manager, quality manager, engineer, test engineer, test operator, technical writer, etc.

Following are exemplary details regarding the aforementioned functions. The function OEM/Production manager consists in managing a product line of a product portfolio, with respect to the technical specifications of the products (and the related components) included in the product line. The function OEM/Quality manager is similar to the function OEM/Production manager, with a focus on the compliance of the products (and the related components) with respect to the technical specifications. The function OEM/Engineer consists in generating the technical specifications of a specific component of the product portfolio. The function Supplier n/test operator consists in testing a specific component of the product portfolio, using technical specifications (and test assets) related to the specific component, and generating test data (e.g. test results). The function OEM/Test engineer consists in analyzing the test data related to a specific component, and deploying updates of test specifications and test assets throughout the supply chain. The function OEM/Technical writer consists in generating test assets, for instance collaterals (e.g. documentation and data) to configure and use test stations. And the function Supplier n/Production manager is similar to the function OEM/Production manager, but its scope is limited to the components manufactured by the Supplier n. Further, for the OEM, the function Production manager may focus on design and technical specification. While for the Supplier n, the function Production manager may focus on operational aspects of the production and testing.

FIG. 6 illustrates the notion of function for component 2, manufactured by supplier n, and included in product 2 owned by the OEM. The term supplier n is used instead of tier n supplier in FIG. 6 for simplification purposes. For the technical specifications, the access rights are granted as follows: owner for function OEM/Production manager, creator for function OEM/Engineer, reader for functions Supplier n/Test operator and Supplier n/Production manager, updater for function OEM/Engineer. For the test assets, the access rights are granted as follows: owner for function OEM/Production manager, creator for function OEM/Technical writer, reader for function Supplier n/Test operator, updater for function OEM/Technical writer. For the test data, the access rights are granted as follows: owner for function OEM/Quality manager, creator for function Supplier n/Test operator, reader for functions OEM/Test engineer and OEM/Production manager, updater is not allocated to any function (the results of the tests cannot be modified).

Several instances of a function may be defined for the same member of the supply chain hierarchy, to take into consideration the fact that this member handles several components of the product portfolio, which must be processed separately for confidentiality reasons. For example, as illustrated in FIG. 6, the OEM manufactures two products: product 1 and product 2. A first instance of the function OEM/Engineer may be defined for product 1 (and the components included in product 1). This instance is granted the following access rights: creator and updater for the technical specifications of product 1 (and the components included in product 1). And a second instance of the function OEM/Engineer may be defined for product 2 (and the components included in product 2, e.g. component 1 and component 2). This instance is granted the following access rights: creator and updater for the technical specifications of product 2 (and the components included in product 2).

Similarly, the supplier n may manufacture two components: component A included in product 1 and component B included in product 2. A first instance of the function Supplier n/Test operator is defined for component A. This instance is granted the following access rights: reader for the technical specifications of component A, reader for the test assets of component A, and creator for the test data of component A. And a second instance of the function Supplier n/Test operator is defined for component B. This instance is granted the following access rights: reader for the technical specifications of component B, reader for the test assets of component B, and creator for the test data of component B.

Although a tier n supplier (supplier n) has been represented in FIG. 6, a contract manufacturer may be represented in place of the tier n supplier, since it plays a similar role in the supply chain hierarchy (manufacturing of components, and more specifically hardware parts for a contract manufacturer).

Although FIG. 6 illustrates a product portfolio owned by a single OEM, a federated product portfolio may be used to manage several OEMs. For this purpose, the product portfolio roots of all the OEMs may be aggregated under a federated product portfolio root. In this case, some tier n suppliers or contract manufacturers, which manufacture components for different OEMs, may appear in several branches of the federated product portfolio hierarchy (corresponding to the different OEMs).

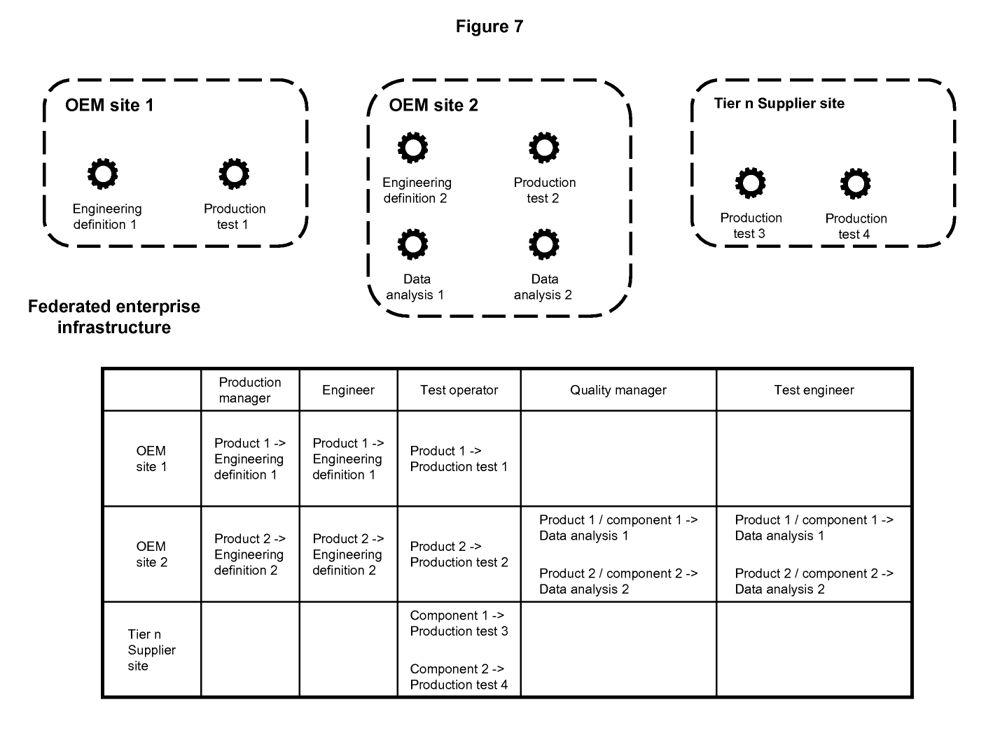

In another aspect, referring now to FIG. 7, a federated enterprise infrastructure will be described.

In the federated enterprise infrastructure, a (logical) function defined in the product portfolio is mapped to a (physical) service for implementing the (logical) function. The service may consist of a hardware platform, and a dedicated software executed on the hardware platform, to implement the function. Further, the service operates on specific data types defined in the product portfolio, in relation to the function. Thus, the service is a physical entity of the federated enterprise infrastructure.

The federated enterprise infrastructure consists in federating all the services available at the premises of the members of the supply chain hierarchy. Each member of the supply chain hierarchy has its own enterprise infrastructure, to manage its own resources (network infrastructure, hardware platforms, softwares, etc). The federated enterprise infrastructure bypasses each specific enterprise infrastructure, to make a specific service available to any actor of the supply chain hierarchy (for using the service), or to any equipment of the supply chain hierarchy (for transmitting data to the service). The availability of the service to an actor or an equipment is based on the access rights defined in the product portfolio.

The federated enterprise infrastructure provides two functionalities. First functionality: automatic transmission of a specific data (of a specific type) generated by a first service (executed on an emitting equipment), to a second service (executed on a receiving equipment). The second service uses this specific data, to implement the function associated to the service. Second, functionality: automatic management of the access rights of an actor of the supply chain hierarchy to a service, to generate or use a specific type of data when executing the service.

The second functionality also includes securing the transmission of the data (not represented in FIG. 7). For this purpose, a security infrastructure may be deployed over the federated enterprise infrastructure. This security infrastructure may be based on a hierarchy of certificates and a Public Key Infrastructure (PKI). An emitting equipment digitally signs a data to be transmitted with a certificate. The data is then transmitted over an encrypted layer (e.g using the Secure Socket Layer (SSL) protocol), between the emitting equipment and the receiving equipment. The encrypted layer avoids interception of the data by an unauthorized third party. The data received by the receiving equipment is validated through its digital signature. The validation includes validating the source of the data (data origin authentication). The validation also includes validating the integrity of the data (the data has not been modified) and the non-replay of the data.

The PKI is built around a chain of trust, through a hierarchy of certificate having a top signing Authority. An OEM has its own certificate, created by the top signing Authority, and used to create digital certificates for two kinds of resources. First, one certificate per member of the supply chain hierarchy (e.g. the tier n suppliers). These certificates are used to sign and authenticate data messages exchanged between the members of the supply chain hierarchy and/or the OEM. Then optionally, one SSL certificate per emitting equipment. These certificates are used to encrypt the communications between members of the supply chain hierarchy and/or the OEM.

For illustration purposes, FIG. 7 represents two different premises of an OEM: OEM site 1 and OEM site 2. And one premises of a tier n supplier: tier n supplier site. OEM site 1 comprises two services: Engineering definition 1 and Production test 1. OEM site 2 comprises four services: Engineering definition 2, Production test 2, Data analysis 1 and Data analysis 2. The tier n supplier site comprises two services: Production test 3 and Production test 4. We consider that the OEM manufactures two products: product 1 and product 2. And the tier n supplier manufactures two components: component 1 and component 2.

A tier n supplier has been represented in FIG. 7 for illustration purposes. However, a contract manufacturer may be represented as well, in place of the tier n supplier.

The table represented in FIG. 7 illustrates the mapping of a function for a component of the product portfolio, to a service. As previously mentioned, a function consists of a combination of a member of the supply chain hierarchy, and a role of an actor of the supply chain hierarchy.

The function OEM/Production manager for product 1 is mapped to the service Engineering definition 1, located at OEM site 1. And the function OEM/Production manager for product 2 is mapped to the service Engineering definition 2, located at OEM site 2.

The function OEM/Engineer for product 1 is mapped to the service Engineering definition 1, located at OEM site 1. And the function OEM/Engineer for product 2 is mapped to the service Engineering definition 2, located at OEM site 2.

The function OEM/Test operator for product 1 is mapped to the service Production test 1, located at OEM site 1. The function OEM/Test operator for product 2 is mapped to the service Production test 2, located at OEM site 2. The function Tier n Supplier/Test operator for component 1 is mapped to the service Production test 3, located at the tier n supplier site. And the function Tier n Supplier/Test operator for component 2 is mapped to the service Production test 4, located at the tier n supplier site.

The function OEM/Quality manager for product 1 and component 1 is mapped to the service Data analysis 1, located at OEM site 2. And the function OEM/Quality manager for product 2 and component 2 is mapped to the service data analysis 2, located at OEM site 2.

The function OEM/Test engineer for product 1 and component 1 is mapped to the service Data analysis 1, located at OEM site 2. And the function OEM/Test Engineer for product 2 and component 2 is mapped to the service Data analysis 2, located at OEM site 2.

As illustrated in FIG. 7, a given service may be shared between several functions. For example, Data analysis 1 is shared between the functions: OEM/Quality manager for product 1, OEM/Quality manager for component 1, OEM/Test engineer for product 1, and OEM/Test engineer for component 1. An actor of the supply chain hierarchy assigned to one of these four functions is granted access to the service Data analysis 1. For instance, he may access the hardware and software implementing Data analysis 1 on OEM site 2. However, the actor may only access the data for which he owns an access right, as defined in the product portfolio. For example, if the actor is a Test engineer for product 1, he may have access to data of type test data only, related to product 1 exclusively.

In another aspect, the transmission of data between an emitting equipment and a receiving equipment is performed by means of a dedicated network infrastructure.

The emitting equipment may be located at the premises of a first enterprise (e.g an OEM). And the receiving equipment may be located at the premises of a second enterprise (e.g. a tier n supplier). Each enterprise has its own independent network infrastructure, with its own security mechanisms (e.g. firewalls). Thus, the transmission of data may require specific network and security configurations, at the premises of each enterprise.

A dedicated network infrastructure is deployed independently of the network infrastructure of each enterprise involved in the supply chain hierarchy. The dedicated network infrastructure enables direct and independent communications between an emitting equipment and a receiving equipment, for the transmission of data related to a component of the product portfolio.

In a particular aspect, the dedicated network infrastructure comprises a wide area wireless data network, for communicating between premises of the multi level supply chain hierarchy. And the dedicated network infrastructure comprises self-organized local area wireless data networks, for communicating within premises of the multi level supply chain hierarchy.

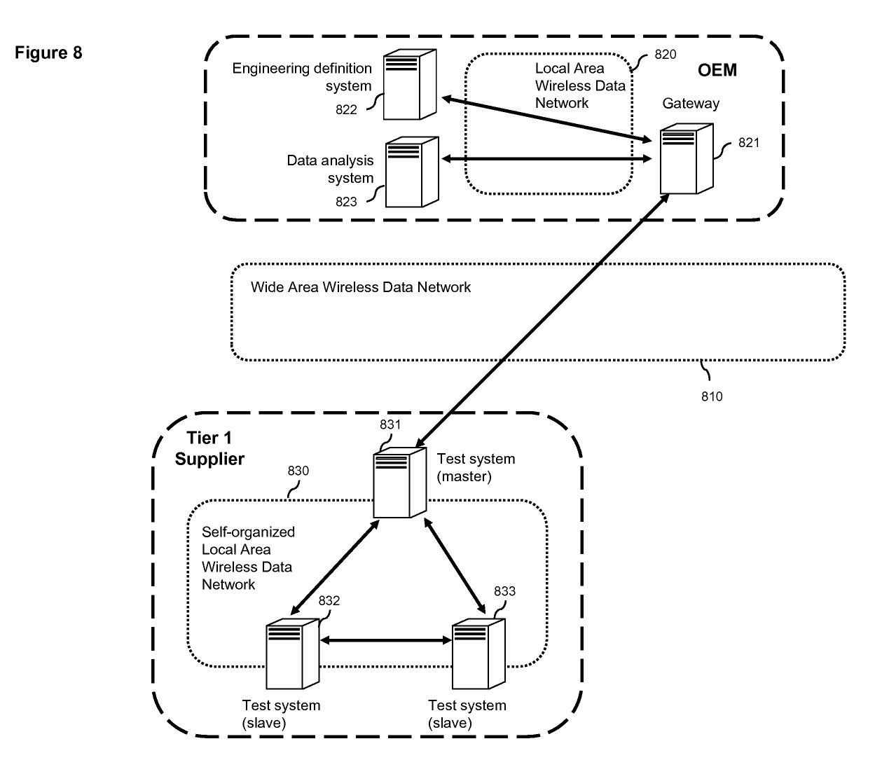

Referring now to FIG. 8, a dedicated network infrastructure will be described. The premises of two members of the multi level supply chain hierarchy are represented in FIG. 8: the premises of an OEM, and the premises of a tier 1 supplier. A wide area wireless data network 810 is used for communications between the OEM premises and the tier 1 supplier premises. A local area wireless data networks 820 is used for communications within the premises of the OEM. A self-organized local area wireless data networks 830 is used for communications within the premises of the tier 1 supplier.

The OEM premises comprise two emitting/receiving equipments: an engineering definition system 822 and a data analysis system 823. These two equipments are connected to the local area wireless data networks 820. A gateway 821 is used at the OEM premises, to connect the local area wireless data network 820 to the wide area wireless data network 810. Although the local area wireless data network 820 represented in FIG. 8 is not self-organized, it may be self organized in an alternative embodiment.

The tier 1 premises comprise three emitting/receiving equipments: a first test system 831, a second test system 832, and a third test system 833. The test system 831 is used at the tier 1 premises, to connect the self-organized local area wireless data network 830 to the wide area wireless data network 810.

The local area wireless data networks 830 is self organized in the sense that the emitting/receiving equipments at the tier 1 premises automatically configure and establish the proper network connectivity. The test system 831 is configured as a master. Thus, it establishes a connection with the wide area wireless data network 810. Further, it configures and establishes the self-organized local area wireless data networks 830. The test systems 832 and 833 are configured as slaves. Thus, they connect to the self-organized local area wireless data networks 830, established by the master test system 831.

A transmission of data between an emitting equipment (for instance the engineering definition system 822) and a receiving equipment (for instance the test system 832) proceeds as follows. The data is transmitted from the engineering definition system 822, to the gateway 821, via the to the local area wireless data networks 820. The data is then transmitted from the gateway 821 to the master test system 831, via the wide area wireless data network 810. And the data is transmitted from the master test system 831 to the slave test system 832, via the self-organized local area wireless data networks 830.

In another aspect, the product portfolio and the federated enterprise infrastructure are represented by a distributed data model. And the data model is distributed at several premises of the multi level supply chain hierarchy. Each of the several premises hosts a full copy of the distributed data model.

Referring now to FIG. 1, the computer implemented storage system 10 memorizes the distributed data model representing the product portfolio and the federated enterprise infrastructure.

An instance of the computer implemented storage system 10 may be deployed at the premises of specific enterprises involved in the multi level supply chain hierarchy. With reference to FIG. 1, it may be deployed only at the premises of the OEM, and the tier 1 supplier A. The tier 2 supplier B, and the tier 2 supplier C, may use the instance deployed at the OEM for their operations. The computer implemented storage system 10 may also be deployed at the premises of each enterprise involved in the multi level supply chain hierarchy.

Additionally, a first distributed data model representing the product portfolio may be memorized by a first computer implemented storage system, and instances of the storage system deployed at several premises of the multi level supply chain hierarchy. And a second distributed data model representing the federated enterprise infrastructure may be memorized by a second computer implemented storage system, and instances of the storage system deployed at several premises of the multi level supply chain hierarchy.

Alternatively, the distributed data model may be partially replicated. For example, a full copy of the distributed data model is hosted at the OEM premises. And segments of the distributed data model are hosted at the premises of several tier n suppliers. Each segment hosted at the premises of a specific tier n supplier only contains the information necessary for the operations of this specific tier n supplier.

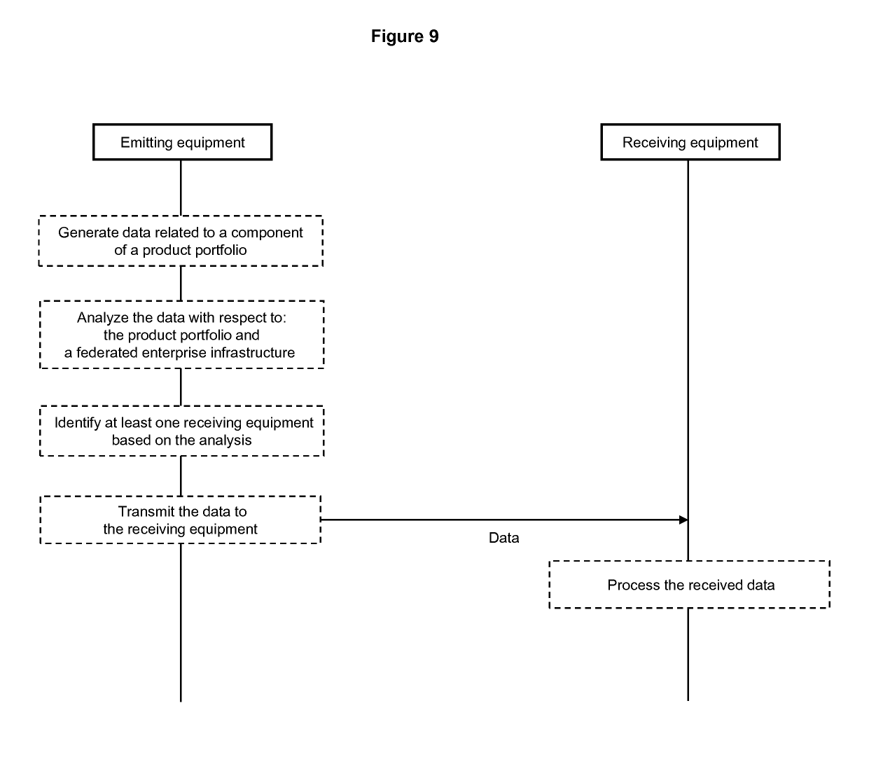

Reference is now made to FIG. 9. The present also relates to a method for dynamic and secure testing and data transmission in a multi level supply chain hierarchy.

The method generates, at an emitting equipment, data related to a component of a product portfolio. The method identifies, at the emitting equipment, a receiving equipment for the data. For identifying the receiving equipment, the method analyzes the data, with respect to the product portfolio and a federated enterprise infrastructure of the multi level supply chain hierarchy. And the method transmits the data, from the emitting equipment to the receiving equipment.

The emitting equipment and the receiving equipment are deployed in the federated enterprise infrastructure of the multi level supply chain hierarchy. The multi level supply chain hierarchy comprises at least one OEM, and N levels of tier n suppliers, with N greater or equal to 1 and n varying from 1 to N.

In a particular aspect of the method, analyzing the data with respect to the product portfolio consists in determining a type of the data, and analyzing the product portfolio to determine a function of the multi level supply chain hierarchy responsible for using the type of data.

In another aspect of the method, analyzing the data with respect to the federated enterprise infrastructure consists in determining the receiving equipment of the federated enterprise infrastructure of the multi level supply chain hierarchy implementing the function.

In a particular aspect of the method, the emitting equipment is an engineering definition system, the data consists in technical specifications, and the receiving equipment is a test system.

In a particular aspect of the method, the emitting equipment is a test system, the data consists in test data, and the receiving equipment is a data analysis system.

In a particular aspect of the method, at least one of the generation of the data at the emitting equipment, the transmission of the data between the emitting equipment and the receiving equipment, and an usage of the data at the receiving equipment, are protected by a security mechanism, wherein the security mechanism prevents an unauthorized actor of the supply chain hierarchy from at least one of: creating, reading, using, and modifying the data.

In another aspect of the method, an authorization for at least one of creating, reading, using, and modifying the data, is granted to an actor of the supply chain hierarchy in relation to an assignment of the actor to a function of the multi level supply chain hierarchy; wherein the function is responsible for the at least one of creating, reading, using, and modifying the data.

In a particular aspect of the method, the transmission of data between the emitting equipment and the receiving equipment is performed by means of a dedicated network infrastructure.

In another aspect of the method, the dedicated network infrastructure comprises a wide area wireless data network, for communicating between premises of the multi level supply chain hierarchy. And the dedicated network infrastructure comprises self-organized local area wireless data networks, for communicating within premises of the multi level supply chain hierarchy.

In a particular aspect of the method, the product portfolio and the federated enterprise infrastructure are represented by a distributed data model. And the data model is distributed at several premises of the multi level supply chain hierarchy.

The steps of the present method can be modified, combined, reordered, performed in sequential steps or group of steps, to accommodate various implementations.

Although the present disclosure has been described in the foregoing description by way of illustrative embodiments thereof, these embodiments can be modified at will, within the scope of the appended claims without departing from the spirit and nature of the appended claims.

What is claimed is:

1. A method for dynamic and secure testing and data transmission in a multi level supply chain hierarchy, the method comprising:
generating at an emitting equipment data related to a component of a product portfolio;
identifying at the emitting equipment a receiving equipment for the data, the identifying comprising analyzing the data with respect to the product portfolio and a federated enterprise infrastructure of the multi level supply chain hierarchy; and
transmitting the data from the emitting equipment to the receiving equipment;
wherein the emitting equipment and the receiving equipment are deployed in the federated enterprise infrastructure of the multi level supply chain hierarchy; the multi level supply chain hierarchy comprising at least one OEM and N levels of tier n suppliers.

2. The method of claim 1, wherein analyzing the data with respect to the product portfolio consists in determining a type of the data, and analyzing the product portfolio to determine a function of the multi level supply chain hierarchy responsible for using the type of data.

3. The method of claim 2, wherein analyzing the data with respect to the federated enterprise infrastructure consists in determining the receiving equipment of the federated enterprise infrastructure of the multi level supply chain hierarchy implementing the function.

4. The method of claim 1, wherein the emitting equipment is an engineering definition system, the data consists in technical specifications, and the receiving equipment is a test system.

5. The method of claim 1, wherein the emitting equipment is a test system, the data consists in test data, and the receiving equipment is a data analysis system.

6. The method of claim 1, wherein at least one of the generation of the data at the emitting equipment, the transmission of the data between the emitting equipment and the receiving equipment, and an usage of the data at the receiving equipment, are protected by a security mechanism, wherein the security mechanism prevents an unauthorized actor of the supply chain hierarchy from at least one of: creating, reading, using, and modifying the data.

7. The method of claim 6, wherein an authorization for at least one of creating, reading, using, and modifying the data, is granted to an actor of the supply chain hierarchy in relation to an assignment of the actor to a function of the multi level supply chain hierarchy; wherein the function is responsible for the at least one of creating, reading, using, and modifying the data.

8. The method of claim 1, wherein the transmission of data between the emitting equipment and the receiving equipment is performed by means of a dedicated network infrastructure.

9. The method of claim 8, wherein the dedicated network infrastructure comprises a wide area wireless data network for communicating between premises of the multi level supply chain hierarchy, and self-organized local area wireless data networks for communicating within premises of the multi level supply chain hierarchy.

10. The method of claim 1, wherein the product portfolio and the federated enterprise infrastructure are represented by a distributed data model; wherein the data model is distributed at several premises of the multi level supply chain hierarchy.

11. A system for dynamic and secure testing and data transmission in a multi level supply chain hierarchy, the system comprising:
at least one computer implemented storage system for storing a product portfolio and a federated enterprise infrastructure of the multi level supply chain hierarchy;
an emitting equipment for:
generating data related to a component of the product portfolio;
identifying a receiving equipment for the data, the identifying comprising analyzing the data with respect to the product portfolio and the federated enterprise infrastructure of the multi level supply chain hierarchy; and
transmitting the data to the receiving equipment; and
the receiving equipment for processing the data;
wherein the emitting equipment and the receiving equipment are deployed in the federated enterprise infrastructure of the multi level supply chain hierarchy; the multi level supply chain hierarchy comprising at least one OEM and N levels of tier n suppliers.

12. The system of claim 11, wherein analyzing the data with respect to the product portfolio consists in determining a type of the data, and analyzing the product portfolio to determine a function of the multi level supply chain hierarchy responsible for using the type of data.

13. The system of claim 12, wherein analyzing the data with respect to the federated enterprise infrastructure consists in determining the receiving equipment of the federated enterprise infrastructure of the multi level supply chain hierarchy implementing the function.

14. The system of claim 11, wherein the emitting equipment is an engineering definition system, the data consists in technical specifications, and the receiving equipment is a test system.

15. The system of claim 11, wherein the emitting equipment is a test system, the data consists in test data, and the receiving equipment is a data analysis system.

16. The system of claim 11, wherein at least one of the generation of the data at the emitting equipment, the transmission of the data between the emitting equipment and the receiving equipment, and an usage of the data at the receiving equipment, are protected by a security mechanism, wherein the security mechanism prevents an unauthorized actor of the supply chain hierarchy from at least one of: creating, reading, using, and modifying the data.

17. The system of claim 16, wherein an authorization for at least one of creating, reading, using, and modifying the data, is granted to an actor of the supply chain hierarchy in relation to an assignment of the actor to a function of the multi level supply chain hierarchy; wherein the function is responsible for the at least one of creating, reading, using, and modifying the data.

18. The system of claim 11, wherein the transmission of data between the emitting equipment and the receiving equipment is performed by means of a dedicated network infrastructure.

19. The system of claim 18, wherein the dedicated network infrastructure comprises a wide area wireless data network for communicating between premises of the multi level supply chain hierarchy, and self-organized local area wireless data networks for communicating within premises of the multi level supply chain hierarchy.

20. The system of claim 11, wherein the product portfolio and the federated enterprise infrastructure are represented by a distributed data model; wherein the data model is distributed at several premises of the multi level supply chain hierarchy.
